(19) United States
(12) Patent Application Publication
(10) Pub. No.: US 2008/0100619 A1
(43) Pub. Date: May 1, 2008

(54) Mesh generation method and computer-readable article for executing the method

(75) Inventors: Ching-Chang Chien, Hsinchu City (TW); Kuo-Chen Lee, Hsinchu City (TW); Cheng-Yung Liu, Hsinchu City (TW); Chia-Hsiang Hsu, Hsinchu City (TW); Rong-Yeu Chang, Hsinchu City (TW)

Correspondence Address: BACON & THOMAS, PLLC, 625 SLATERS LANE, FOURTH FLOOR, ALEXANDRIA, VA, 22314, US

(73) Assignee: CoreTech System Co., Ltd., Hsinchu City (TW)

(21) Appl. No.: 11/709,269

(22) Filed: Feb. 22, 2007

(30) Foreign Application Priority Data
Oct. 25, 2006 (TW) 095139406

(51) Int. Cl. G06T 15/30

(52) U.S. Cl. 345/423

(57) ABSTRACT

A method for generating meshes and a computer-readable article for executing the method are disclosed. The method comprises the steps of: generating a plurality of hexahedral meshes for a model; creating a runner for the model; generating a plurality of meshes for the runner; and modifying the runner meshes located at an intersection area between the model and the runner so that each node of each runner mesh maps to a corresponding node.

### BACKGROUND OF THE INVENTION

1. Field of the Invention

The present invention relates to a mesh generation method, and more particularly, to a mesh generation method applied for an analysis of injection-molding simulation.

2. Description of the Related Art

Generally speaking, when conducting a computer-aided engineering analysis, a simulated object needs to be divided into meshes by a computer. These meshes form a close representation of the simulated object model, so that it can be analyzed through numerical methods such as FDM, FEM, FVM or FEM. Therefore, a three-dimensional object model has to be divided into three-dimensional meshes for further analysis. There are usually four types of three-dimensional meshes, which include tetrahedral, pyramidal, prismoid and hexahedral meshes. When the model is divided in the direction of X, Y, and Z-axis, each divided element will be rectangular shaped (hexahedral) and these rectangular elements can be used as building blocks to construct the entire model. The meshes can be easily generated through this method and it is highly efficient thereby greatly reducing the preparation time for mesh generation.

Moreover, the runner needs to be considered inside the mold design to become a part of the plastic injection-molding process. Since the process of making the component and its final outcome is influenced by factors such as the plastic viscosity, which may cause uneven flow of the liquid plastic along the runner; the path, which the liquid plastic flows along inside the runner; and the distance, which is the length where liquid plastic flows; thus, it is critical to include runner analysis into the simulation to obtain a more realistic result.

However, the model meshes constructed by the hexahedral elements posses quadrilateral mesh surfaces. Therefore, the solid runner meshes must be constructed by extending the quadrilateral mesh surfaces outward, and the solid runner meshes also complying with the actual runner geometry (for example, conical shape). With this, it is necessary to provide a mesh generation method which can accommodate hexahedral elements and runner geometry simultaneously.

### SUMMARY OF THE INVENTION

In order to resolve the problems in the prior art, the present invention provides a new method for generating meshes and a computer-readable article for executing the method which is applied during the analysis in computer aided engineering.

The method comprises the following steps: generating a plurality of model meshes for the model; creating a runner for the model; generating a plurality of runner meshes for the runner; and modifying the plurality of runner meshes or model meshes at an intersection area located between the model and the runner so that each runner mesh node maps to a corresponding model mesh node.

In one embodiment of the present invention, at least a line is constructed on the model; the attribute of the line is set as a runner, and the diameter size is set for the formation of the runner.

In one embodiment of the present invention, the runner meshes which are located closer to the model at the intersection area are divided into 8N-4 meshes in each mesh layer with N being the nth position located from the cross-sectional center of each mesh layer. The runner meshes which are located further away from the model are divided into 16N-8 meshes in each mesh layer with N being the nth position located from the cross-sectional center of each mesh layer.

In one embodiment, the present invention uses the cross-sectional center of the runner meshes located closer to the intersection area of the model as the center point, and process radially outward by dividing each mesh into two meshes, such that 8N-4 runner meshes become a total of 16N-8 runner meshes. The node mapping relationships will be created such that each 16N-8 runner mesh node located closer to the model is mapped to a corresponding 16N-8 runner mesh node located further away from the model.

Furthermore, the present invention provides a computer-readable article which can be used in the analysis of computer aided engineering. The article includes a recordable program medium, and the medium further comprises a first program code, a second program code, a third program code and a fourth program code which is used for the mesh generation method of the present invention.

### BRIEF DESCRIPTION OF THE DRAWINGS

FIG. 1 is a process flow chart showing a method of mesh generation of the present invention.

FIG. 2 is a diagram showing a method of creating model meshes in accordance with the present invention.

FIG. 3 is a diagram showing a method of creating a runner for a model in accordance with the present invention.

FIG. 4 is a diagram showing a method of creating runner meshes in accordance with the present invention.

FIG. 5 is a diagram of runner meshes in accordance with the present invention.

FIG. 6A is a diagram showing triangular runner meshes in accordance with the present invention.

FIG. 6B is a diagram showing quadrilateral runner meshes in accordance with the present invention.

FIG. 6C is a diagram showing cutting of runner meshes in accordance with the present invention.

FIG. 7A and FIG. 7B are diagrams which show mapping relationships between each node in accordance with the present invention.

FIG. 8 is a diagram showing a computer-readable article in accordance with the present invention.

### DETAILED DESCRIPTION OF THE PREFERRED EMBODIMENT

The advantages and innovative features of the invention will become more apparent from the following detailed description when taken in conjunction with the accompanying drawings.

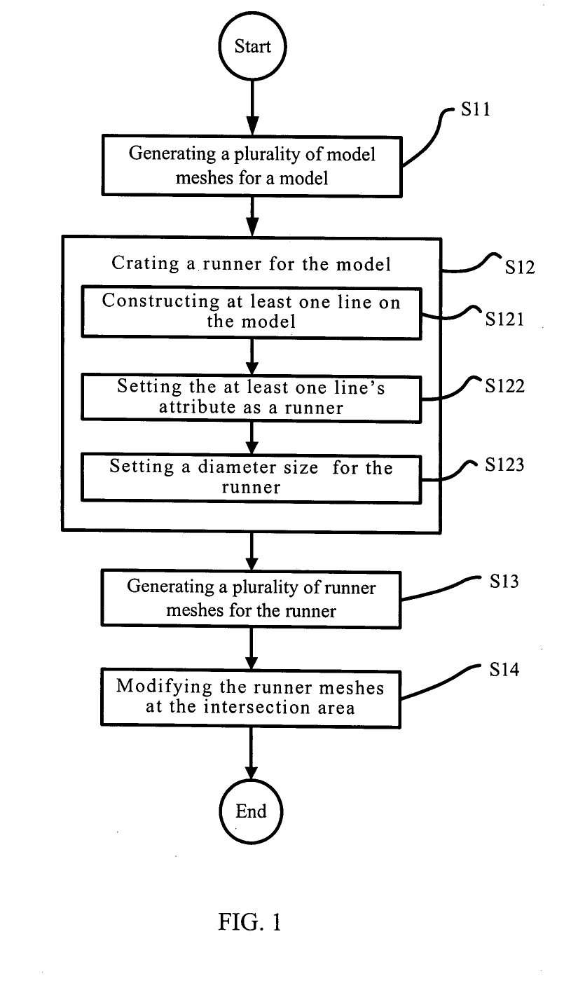

The present invention first provides a method for mesh generation. Refer to FIG. 1 for process flow chart showing the method of mesh generation in accordance with the present invention. As depicted in FIG. 1, the method for mesh generation including steps S11, S12, S13 and S14.

As shown in FIG. 1, the present invention starts with step S11, which divides a model into meshes to generate a plurality of model meshes. Generally in the prior technology, an object needs to be divided into three-dimensional meshes by the computer before numerical analysis of computer aided engineering can be conducted. Usually, a three-dimensional object model needs to be divided into three-dimensional meshes, and these meshes can be classified into four types including tetrahedral, pyramid, prismoid and hexahedral. Normally, the quality of the mesh will affect the accuracy of the numerical analysis which will impact the final result.

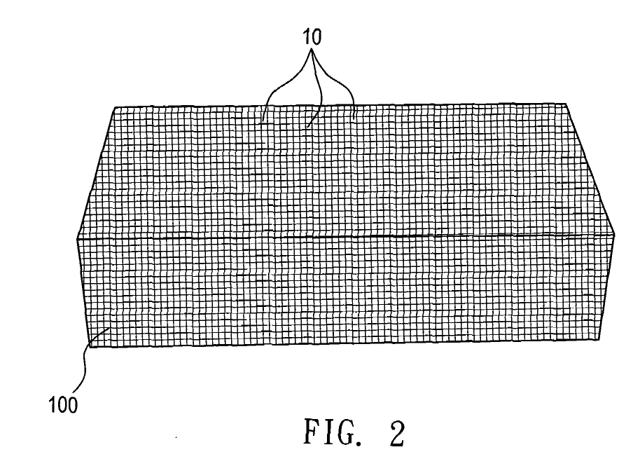

In one embodiment of the present invention, Voxel method is used to create the meshes, which means the model is divided from the direction of X, Y, and Z-axis, and these mesh elements are rectangular shaped (hexahedral). Refer to FIG. 2 which shows a method of creating model meshes for one of the embodiments in accordance with the present invention. As shown in FIG. 2, the Voxel method is used to create the meshes using the step S11, and the plurality of hexahedral (rectangular shape) meshes 10 can be used as building blocks to construct the complete model 100. The reason that Voxel method is used to create the meshes is that the meshes can be easily generated through this method and it is highly efficient, which greatly reduces the preparation time for mesh generation. Moreover, in one embodiment of the present invention, the plurality of hexahedral meshes 10 can be generated through CAD modeling or triangular mesh stereolithography (STL) file. Due to the fact that persons skilled in the art of mesh generation are familiar with Voxel, and are able to obtain the mesh generation technique using CAD models and STL format files, it will not be explained further. Take note that the plurality of hexahedral meshes 10 generated in step S11 are solid meshes, so that they can be used in true three-dimensional analyses.

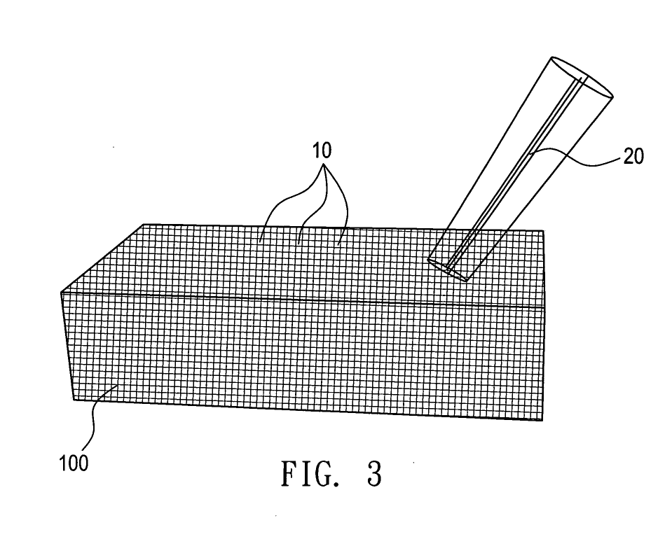

Next, the present invention proceeds with step S12 which creates a runner in the model. As shown in FIG. 1 step S12 further includes the following steps: step 121: creating at least one line on the model; step 122: setting at least one line's attribute as a runner; and step 123: setting the diameter size for the formation of the runner. FIG. 3 shows the construction of runner 20 on the plurality of hexahedral meshes 10 in the model 100 through step S12.

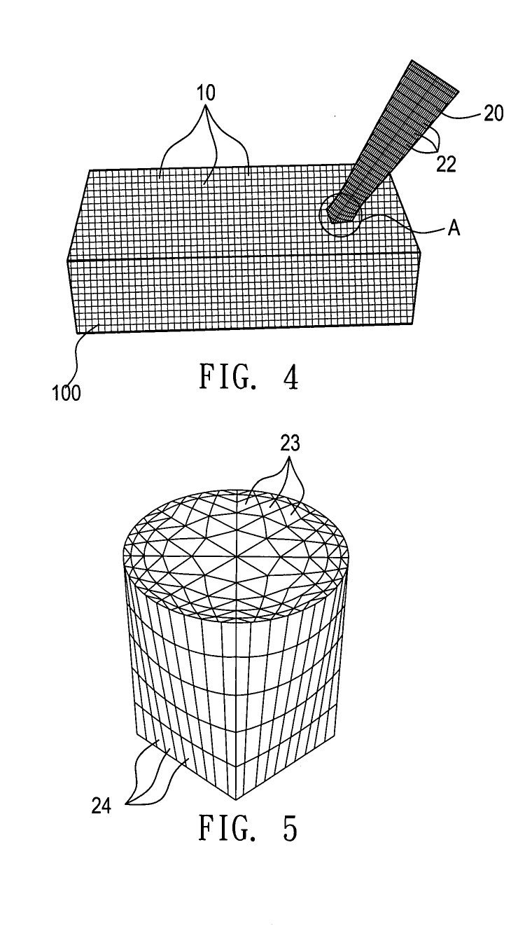

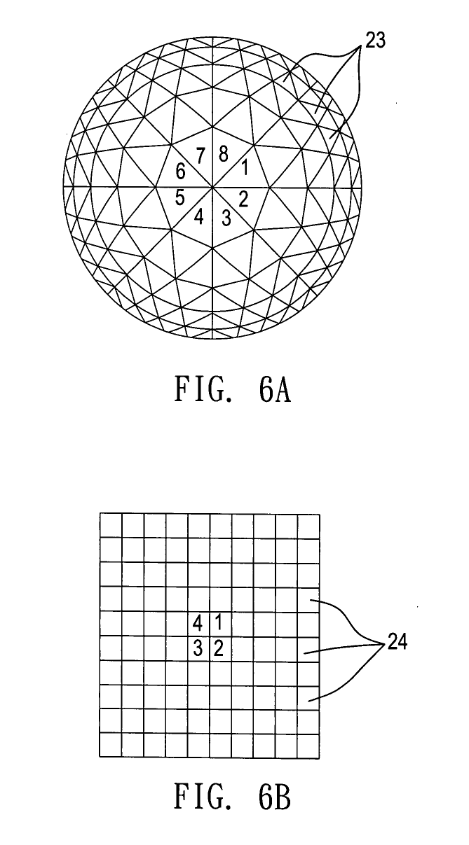

As shown in FIG. 1, after step S11 and S12 are completed, the present invention then proceeds with step S13 to divide the runner into a plurality of runner meshes. FIG. 4 is a diagram showing the generation of the plurality of runner meshes 22 through step S13 in accordance with the present invention. Through step S13 as shown in FIG. 4, the present invention is able to generate the plurality of runner meshes 22 from the runner 20, wherein the runner 20 is constructed on the plurality of hexahedral meshes 10 of the model 1. Take note that the plurality of the hexahedral meshes 10 created through step S11 contains quadrilateral cross-sectional surfaces. Thus, as shown in FIG. 4, the plurality of runner meshes 22 created through step S13 must take the plurality of quadrilateral cross-sectional surface of the model meshes 10 into consideration by using it as a construction basis, and it must also comply with the geometry of the runner 20. Therefore, in one embodiment as shown in FIG. 5, the plurality of the solid runner meshes 22 created through step S13 will include the solid runner meshes 23 having triangular cross-sectional surfaces and the solid runner meshes 24 having hexahedral cross-sectional surfaces. However, the present invention is not confined to this formation, as the solid runner meshes 22 can also exclusively contain solid runner meshes 23 having triangular cross-sectional surfaces.

The present invention is not only able to generate uniform plurality of the model meshes 10 and the runner meshes 22 automatically, but it can also automatically generate adaptive model meshes 10 and runner meshes 22, such that the intersection area A as shown in FIG. 4 is able to generate a higher concentration meshes in order to attain a better analysis. Due to the fact that persons skilled in the art of mesh generation are familiar with the adaptive mesh generation method, it will not be explained further.

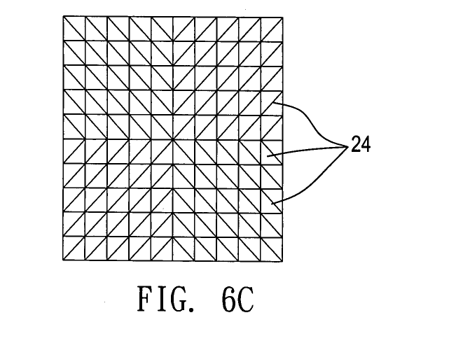

Next, the present invention proceeds with step S14 which modifies the intersection area A located between the plurality of model meshes and the plurality of runner meshes, so that each node in the plurality of model meshes 10 maps to a corresponding node in the plurality of runner meshes 22. To comply with actual geometry of the runner 20, the plurality of model meshes 10 having quadrilateral cross-sectional surfaces are used as the basis, and they are then extended outwards to construct the plurality of runner meshes 22 in step S13. Thus, if the geometry of the runner 20 is conical-shaped as shown in FIG. 3 and FIG. 4, then the intersection area A of the model meshes and the runner meshes will either be formed into the solid runner meshes 23 with triangular cross-sectional surfaces as shown in FIG. 6A or into solid runner meshes 24 with quadrilateral cross-sectional surfaces as shown in FIG. 6B. Next, step 14 modifies the plurality of meshes at the intersection area A such that each node in the plurality of meshes 23 maps to a corresponding node in the plurality of meshes 24, which enables further analysis.

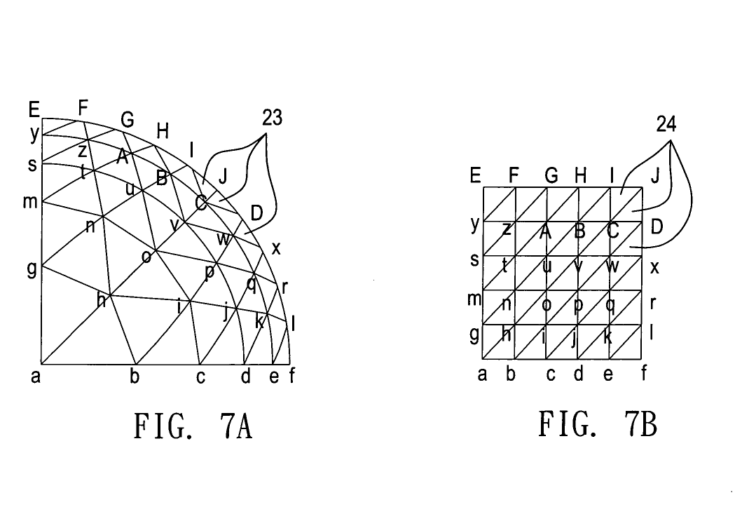

As shown in FIG. 6A, the plurality of meshes 23 are arranged into 16N-8 meshes with N being the nth position located from the cross-sectional center. For example, when it is one position away from the cross-sectional center, there are 8 meshes consisting of meshes 11, 12, 13, 14, 15, 16, 17 and 18 (16×1−8=8). Similarly, the plurality of meshes 24 are arranged into 8N-4 meshes with N being the nth position located from the cross-sectional center. For example, when it is one position away from the cross-sectional center, there are 4 meshes consisting of mesh 1, 2, 3 and 4 (8×1−4=4) as shown in FIG. 6B. Thus, as shown in FIG. 6C, step S14 of the present invention uses the cross-sectional center of the plurality of meshes 24 as a center point, and proceeds radially outward to each mesh layer by dividing each mesh obtained from 8N-4 meshes into two meshes such that it becomes a total of 16N-8 meshes. Thus, quantity of the plurality of meshes 23 and the plurality of meshes 24 will be the same. Next, each node of the plurality of meshes 24, arranged as 16N-8 meshes with N being the nth position away from the cross-sectional center, are mapped to the corresponding node of the plurality of meshes 23, which are also arranged as 16N-8 meshes with N being the nth position away from the cross-sectional center. For example, by taking a fourth of the surface area from FIG. 6A and FIG. 6B, the present invention is able to create the mapping relationships through step S14. As shown in FIGS. 7A and 7B, each node in the plurality of meshes 23 is mapped to each corresponding node in the plurality of meshes 24. Next, information of these mapping relationships is used to calculate the heat exchange between the meshes, so that varying numerical analyses of model 100, such as the cooling analyses, can be conducted.

Take note that the procedure of the present invention is not confined to the steps as shown in FIG. 1. Those skilled in the art should be able to understand the present object and still be able to achieve the same object by following the step sequence other than the steps as depicted in FIG. 1. For example, the object of the present invention can also be achieved by first creating a runner on the model through step S12, and then dividing the model into meshes through step S11.

Furthermore, there are other modification methods which are able to accomplish the mapping of each node in the plurality of model meshes to each node in the plurality of runner meshes at the intersection area. The present invention is able to achieve the same object through different ways, and is not confined to the aforementioned method. For example, in step S14 of the present invention, we can also treat the cross-sectional center of the plurality of meshes 23 as the central point, and proceeds radially outward to each mesh layer by merging two meshes obtained from the 16N-8 meshes into a single mesh such that it becomes a total of 8N-4 meshes. Thus, quantity of the plurality of meshes 23 and the plurality of meshes 24 will be the same. Next, the node of each mesh of the plurality of meshes 23, which are arranged as 8N-4 meshes with N being the nth position away from the cross-sectional center, are mapped to corresponding node of each mesh of the plurality of meshes 23, which are also arranged into 8N-4 meshes with N being the nth position away from the cross-sectional center.

Furthermore, if the plurality of runner meshes 22 created in step S13 only consists of the solid runner meshes 23 with triangular cross-sectional surfaces, step S14 of the present invention will take a pair of meshes located at the nth position from the cross-sectional center and merge them into a single mesh so that it becomes a total of 8N-4 meshes. As a result, each node can be mapped to the corresponding nodes in model meshes 10, which consists of 8N-4 meshes with N being the position located from the cross-sectional center. As an alternative, step S14 of the present invention is able to divide each mesh obtained from the 8N-4 meshes, with N being the position located from the cross-sectional center of the model meshes 10, into two meshes such that it becomes a total of 16N-8 meshes. Each node can then be mapped to the corresponding node of 16N-8 meshes, with N being the position located from the cross-sectional center of the runner meshes 23.

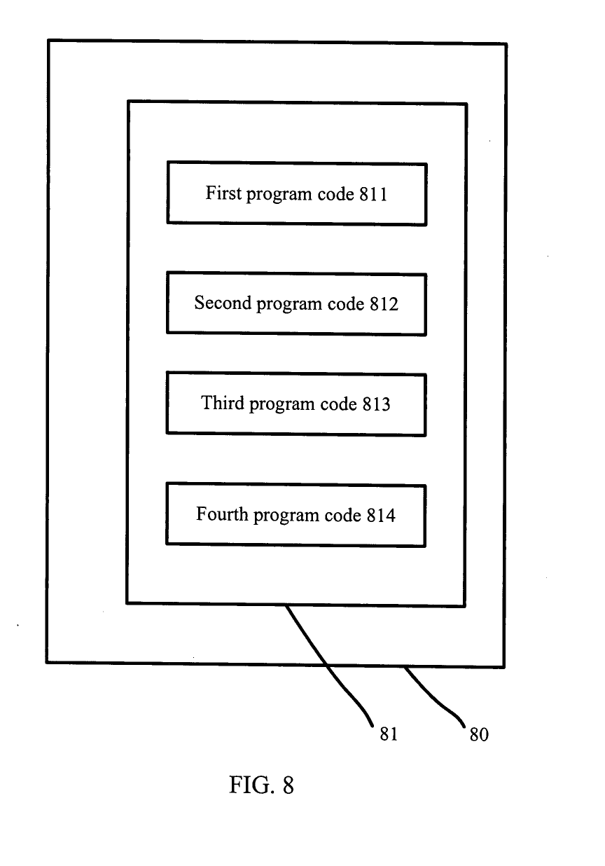

Next, as shown in FIG. 8, the present invention provides a computer-readable article 80 which can be used in the analysis of computer aided engineering. The article 80 includes a recordable program medium 81, and the medium 81 further comprises: a first program code 811 which is used to execute step S11, a second program code which is used to execute step S12, a third program code 813 which is used to execute step S13, and a fourth program code 814 which is used to execute step S14 of the mesh generating method for the present invention. The functionality of the program code is explained in detail, so it will not be explained further here.

Although the present invention has been explained in relation to its preferred embodiment, it is to be understood that many other possible modifications and variations can be made without departing from the spirit and scope of the invention as hereinafter claimed.

What is claimed is:

1. A mesh generation method, the method comprising the steps of:
generating a plurality of model meshes for a model;
creating a runner for the model;
generating a plurality of runner meshes for the runner; and
modifying the plurality of runner meshes or model meshes at an intersection area located between the model and the runner so that each node of the plurality of runner meshes maps to a corresponding node of the plurality of model meshes.

2. The method as claimed in claim 1, wherein the step of creating the runner for the model comprises:
constructing at least one line on the model;
setting an attribute of the at least one line as the runner; and
setting a diameter size for the runner for forming the runner.

3. The method as claimed in claim 1, wherein the runner meshes which are located closer to the model at the intersection area are divided into 8N-4 meshes in each mesh layer with N being the nth position located from a cross-sectional center of each mesh layer, wherein the runner meshes which are located further away from the model are divided into 16N-8 meshes in each mesh layer with N being the nth position located from a cross-sectional center of each mesh layer.

4. The method as claimed in claim 3, wherein the step of modifying the plurality of runner meshes or model meshes at the intersection area located between the model and the runner comprises the following steps:
using the cross-sectional center of each mesh layer of the plurality of runner meshes which are closer to the model as a center point, and proceeding radially outward to each mesh layer by dividing each mesh obtained from the 8N-4 meshes into two meshes such that it becomes a total of 16N-8 runner meshes; and
creating node mapping relationships such that each 16N-8 runner mesh node locating closer to the model is mapped to a corresponding 16N-8 runner mesh node locating further away from the model.

5. The method as claimed in claim 3, wherein the step of modifying the plurality of runner meshes or model meshes at the intersection area located between the model and the runner comprises the following steps:
using the cross-sectional center of each mesh layer of the plurality of runner meshes which are located further away from the model as a central point, and proceeding radially outward to each mesh layer by taking a pair of meshes obtained from the 16N-8 meshes, merging them into a single mesh such that it becomes a total of 8N-4 runner meshes; and
creating node mapping relationships such that each 8N-4 runner mesh node locating closer to the model is mapped to a corresponding 8N-4 runner mesh node locating further away from the model.

6. The method as claimed in claim 1, wherein the plurality of model meshes consists of 8N-4 meshes in each mesh layer with N being the nth position located from a cross-sectional center of each mesh layer of the model meshes, and the plurality of runner meshes consists of 16N-8 meshes in each mesh layer with N being the nth position located from a cross-sectional center of each mesh layer of the runner meshes.

7. The method as claimed in claim 6, wherein the step of modifying the plurality of runner meshes or model meshes at the intersection area located between the model and the runner comprises the following steps:
using the cross-sectional center of each mesh layer of the model meshes as a central point, and proceeding radially outward to each mesh layer by dividing each mesh which located at the nth position from the center into two meshes, such that 8N-4 model meshes become a total of 16N-8 model meshes; and
creating node mapping relationships such that each 16N-8 model mesh node is mapped to a corresponding 16N-8 runner mesh node.

8. The method as claimed in claim 6, wherein the step of modifying the plurality of runner meshes or model meshes at the intersection area located between the model and the runner comprises the following steps:
using the cross-sectional center of each mesh layer of the runner meshes as a center point, and proceeding radially outward to each mesh layer by taking a pair of meshes located at the nth position from the center into a single mesh, such that 16N-8 runner meshes become a total of 8N-4 runner meshes; and
creating node mapping relationships such that each 8N-4 model mesh node is mapped to a corresponding 8N-4 runner mesh node.

9. The method as claimed in claim 1, wherein the step of generating the plurality of model meshes creates a plurality of hexahedral model meshes automatically which complies with geometry of the model.

10. The method as claimed in claim 1, wherein the plurality of model meshes or the plurality of runner meshes are essentially a plurality of solid meshes.

11. The method as claimed in claim 1, wherein the plurality of model meshes or the plurality of runner meshes are generated in an uniform manner automatically.

12. The method as claimed in claim 1, wherein the plurality of model meshes or the plurality of runner meshes are generated in an adaptive manner automatically, such that the intersection area is able to generate a higher concentration of the plurality of model meshes or the plurality of runner meshes.

13. A computer-readable article, which can be used in an analysis of computer aided engineering, the article including a recordable program medium, and the recordable program medium further comprising:
a first program code used to execute the following mechanism:
generating a plurality of model meshes for a model;
a second program code used to execute the following mechanism: creating a runner for the model;
a third program code used to execute the following mechanism:
generating a plurality of runner meshes for the runner;
a fourth program code used to execute the following mechanism: modifying the plurality of runner meshes or model meshes at an intersection area located between the model and the runner so that each node of the plurality of runner meshes maps to a corresponding node of the plurality of model meshes.

14. The computer-readable article as claimed in claim 13, wherein the second program code comprises a code to execute the following mechanisms:
constructing at least one line on the model;
setting an attribute of the at least one line as the runner; and
setting a diameter size for the runner for forming the runner.

15. The computer-readable article as claimed in claim 13, wherein the third program code comprises a code to execute the following mechanisms:
letting the runner meshes which are located closer to the model at the intersection area being divided into 8N-4 meshes in each mesh layer with N being the nth position located from a cross-sectional center of each mesh layer of the runner meshes; and
letting the runner meshes which are located further away from the model being divided into 16N-8 meshes in each mesh layer with N being the nth position located from a cross-sectional center of each mesh layer of the runner meshes.

16. The computer-readable article as claimed in claim 15, wherein the fourth program code comprises a code to execute the following mechanisms:
using the cross-sectional center of each mesh layer of the plurality of runner meshes which are closer to the model as a center point, and proceeding radially outward to each mesh layer by dividing each mesh obtained from the 8N-4 meshes into two meshes such that it becomes a total of 16N-8 runner meshes; and
creating node mapping relationships such that each 16N-8 runner mesh node locating closer to the model is mapped to a corresponding 16N-8 runner mesh node locating further away from the model

17. The computer-readable article as claimed in claim 15, wherein the fourth program code comprises a code to execute the following mechanisms:
using the cross-sectional center of each mesh layer of the plurality of runner meshes which are located further away from the model as a central point, and proceeding radially outward to each mesh layer by taking a pair of meshes obtained from the 16N-8 meshes, merging them into a single mesh such that it becomes a total of 8N-4 runner meshes; and
creating node mapping relationships such that each 8N-4 runner mesh node locating closer to the model is mapped to a corresponding 8N-4 runner mesh node locating further away from the model.

18. The computer-readable article as claimed in claim 13, wherein the first program code comprises a code to execute the following mechanisms:
letting the plurality of model meshes being divided into 8N-4 meshes in each mesh layer with N being the nth position located from a cross-sectional center of each mesh layer of the model meshes;
and the third program code comprises a code to execute the following mechanisms:
letting the plurality of runner meshes being divided into 16N-8 meshes in each mesh layer with N being the nth position located from a cross-sectional center of each mesh layer of the runner meshes.

19. The computer-readable article as claimed in claim 18, wherein the fourth program code comprises a code to execute the following mechanisms:
using the cross-sectional center of each mesh layer of the model meshes as a central point, and proceeding radially outward to each mesh layer by dividing each mesh which located at the nth position from the center into two meshes, such that 8N-4 model meshes become a total of 16N-8 model meshes; and
creating node mapping relationships such that each 16N-8 model mesh node is mapped to a corresponding 16N-8 runner mesh node.

20. The computer-readable article as claimed in claim 18, wherein the fourth program code comprises a code to execute the following mechanisms:
using the cross-sectional center of each mesh layer of the runner meshes as a center point, and proceeding radially outward to each mesh layer by taking a pair of meshes located at the nth position from the center into a single mesh, such that 16N-8 runner meshes become a total of 8N-4 runner meshes; and
creating node mapping relationships such that each 8N-4 model mesh node is mapped to a corresponding 8N-4 runner mesh node.

21. The computer-readable article as claimed in claim 13, wherein when generating the plurality of model meshes, the computer-readable article creates a plurality of hexahedral model meshes automatically which complies with geometry of the model.

22. The computer-readable article as claimed in claim 13, wherein the plurality of model meshes or the plurality of runner meshes are essentially a plurality of solid meshes.

23. The computer-readable article as claimed in claim 13, wherein the plurality of model meshes or the plurality of runner meshes are generated in an uniform manner automatically.

24. The computer-readable article as claimed in claim 13, wherein the plurality of model meshes or the plurality of runner meshes are generated in an adaptive manner automatically, such that the intersection area is able to generate a higher concentration of the plurality of model mesh or the plurality of runner meshes.
